(19) United States
(12) Patent Application Publication
(10) Pub. No.: US 2016/0085988 A1
(43) Pub. Date: Mar. 24, 2016

(54) Management Method and Computer System Thereof

(71) Applicant: Yi-Sheng Shiu, Taichung City (TW)

(72) Inventor: Yi-Sheng Shiu, Taichung City (TW)

(21) Appl. No.: 14/489,482

(22) Filed: Sep. 18, 2014

(51) Int. Cl. G06F 21/62; G06Q 20/40

(52) U.S. Cl. CPC G06F 21/6245; G06Q 20/40

(57) ABSTRACT

A management method for a cloud server system is disclosed. The management method includes accepting registering of a first administer account and a preserved account; and permitting uploading or editing at least one individual information via the first administer account for the cloud server system while a user corresponding to the preserved account does not comply with a predetermined principle, or authorizing the user corresponding to the preserved account to upload or edit the at least one individual information for the cloud server system while the user corresponding to the preserved account complies with the predetermined principle; wherein the predetermined principle is a children online privacy limitation, a user corresponding to the first administer account is a legal guardian for the user corresponding to the preserved account, and the at least one individual information represents a personal identification for the user corresponding to the preserved account.

### BACKGROUND OF THE INVENTION

1. Field of the Invention

The present invention relates to a management method and computer system thereof, and more particularly, to a management method and computer system thereof which can adaptively manage authorities of editing and uploading for at least one individual information of a cloud server system.

2. Description of the Prior Art

Generally, some people know their grow-up through their parents or brothers/sisters in words or goods accompanying their childhood. Since the memory or the preservation may not be reliable all the time, the talking or goods are not thoroughly convincing or persuasive to understand their grow-up. Alternatively, some people have the idea of their childhood through electronic files made or recorded by their parents, such as pictures or videos, but it might be possible to lose the pictures while relocating or to accidentally break down the corresponding storage device stored the videos. Under such circumstances, there is another smarter solution that parents may utilize a cloud server or a social network to preserve and store the electronic files for their children.

According to the Children's Online Privacy Protection Act (COPPA) in the US or other similar laws in other countries, children may not have the authority to have accounts of the cloud server or the social network before they are mature enough (e.g. 13 years old). Thus, it is their parents, rather than the children, who have the conscious administration to upload and edit the electronic files, i.e. the parents are the real administers to edit and upload the electronic files which belong to their children. In such a situation, as the children grow up and are old enough to have an account of the cloud server or the social network, it might not be easy to transfer all the electronic files recording the children's grow-up from parents' accounts to the children's accounts. In other words, the corresponding administration of the electronic files belongs to the uploading account user according to the existing administrative principle of the cloud server or the social network. Accordingly, the grown-up children have no choice but to ask their parents for the uploaded electronic files, or the parents are requested to adaptively modify the authority of editing/uploading of the uploaded electronic files for their children, which results in more redundancy operations and less convenience.

Therefore, it has been an important issue to provide a management method and computer system thereof which can adaptively manage authorities of editing and uploading for at least one individual information of a cloud server system.

### SUMMARY OF THE INVENTION

It is an objective to provide a management method and computer system thereof which can adaptively manage authorities of editing and uploading for at least one individual information of a cloud server system.

The present invention discloses a management method fora cloud server system. The management method includes accepting registering of a first administer account and a preserved account; and permitting uploading or editing at least one individual information via the first administer account for the cloud server system while a user corresponding to the preserved account does not comply with a predetermined principle, or authorizing the user corresponding to the preserved account to upload or edit the at least one individual information for the cloud server system while the user corresponding to the preserved account complies with the predetermined principle; wherein the predetermined principle is a children online privacy limitation, a user corresponding to the first administer account is a legal guardian for the user corresponding to the preserved account, and the at least one individual information represents a personal identification for the user corresponding to the preserved account.

The present invention also discloses a computer system coupled to a cloud server system. The computer system comprises a central processing unit; and a storage device, coupled to the central processing unit and storing a programming code, the programming code is utilized to process a management method for the cloud server system. The management method includes accepting registering of a first administer account and a preserved account; and permitting uploading or editing at least one individual information via the first administer account for the cloud server system while a user corresponding to the preserved account does not comply with a predetermined principle, or authorizing the user corresponding to the preserved account to upload or edit the at least one individual information for the cloud server system while the user corresponding to the preserved account complies with the predetermined principle; wherein the predetermined principle is a children online privacy limitation, a user corresponding to the first administer account is a legal guardian for the user corresponding to the preserved account, and the at least one individual information represents a personal identification for the user corresponding to the preserved account.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a computer system coupled to a cloud server system according to an embodiment of the invention.

FIG. 2 illustrates a flow chart of a management process according to an embodiment of the invention.

FIG. 3 illustrates a timing diagram with related information of the user corresponding to the preserved account in the cloud server system according to an embodiment of the invention.

### DETAILED DESCRIPTION

The specification and the claims of the present invention may use a particular word to indicate an element, which may have diversified names named by distinct manufacturers. The present invention distinguishes the element depending on its function rather than its name. The phrase “comprising” used in the specification and the claim is to mean “is inclusive or open-ended but not exclude additional, un-recited elements or method steps.” In addition, the phrase “electrically connected to” or “coupled” is to mean any electrical connection in a direct manner or an indirect manner. Therefore, the description of “a first device electrically connected or coupled to a second device” is to mean that the first device is connected to the second device directly or by means of connecting through other devices or methods in an indirect manner.

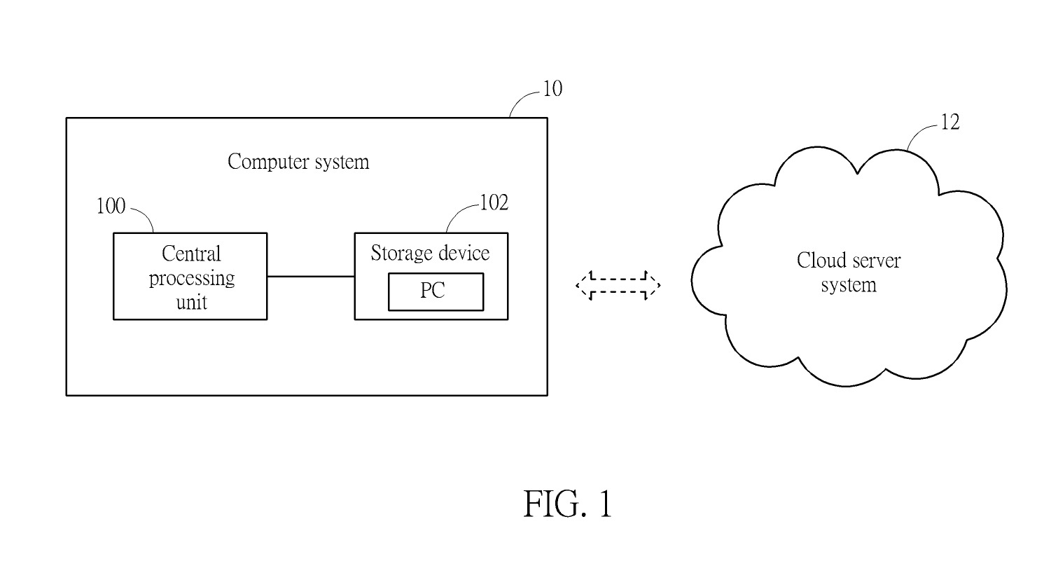

FIG. 1 illustrates a schematic diagram of a computer system 10 coupled to a cloud server system 12 according to an embodiment of the invention. As shown in FIG. 1, the cloud server system 12 can be an network platform for data storage or sharing with adaptive restrictions from administers, and a group of registered users, obeying the restrictions from the administer, can be worldwide to legally access/upload/edit/share their individual information via all kinds of digital information processer, such as a personal computer, a tablet, a digital camera, a laptop, a MP3 player or a mobile device, etc. Also, the communication between the group of registered users and the cloud server system 12 may login with correct password via a wireless/wired connection, which is not limiting the scope of the invention.

The computer system 10 has a basic structure comprising, for example, a main board, a processing unit, a memory, a hard disk, a south-bridge module, a north-bridge module, etc., and should be well known to those skilled in the art. For the brevity, FIG. 1 of the invention only illustrates a central processing unit 100 and a storage device 102 of the computer system 12. The storage device 102 can be, but not limited to, read-only memory (ROM), random-access memory (RAM), flash, floppy disk, hardware disk, compact disc, USB flash drive, tape, database accessed via the Internet, or other types of storage medium known to those skilled in the art, to store a programming code PC, such that the central processing unit 100 can be utilized to process the programming code PC to operate a management method for the cloud server system 12. Certainly, the connection between the computer system 10 and the cloud server system 12 may be a wireless/wired signal transmission, which is not limiting the scope of the invention. Under such circumstances, the management method of the invention may adaptively manage registered users' authorities of editing and uploading for at least one individual information to be preserved in the cloud server system 12.

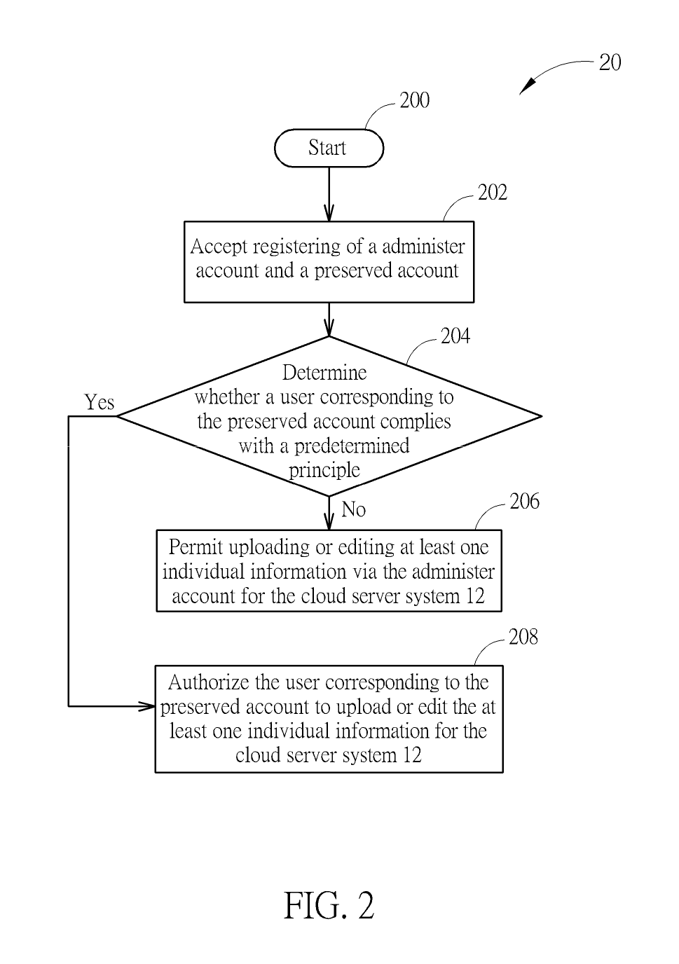

Furthermore, the management method for the cloud server system 12 of the invention can be summarized as a management process 20, as shown in FIG. 2, to be stored in the storage device 102. The management process 20 includes the following steps:

Step 200: Start.

Step 202: Accept registering of a administer account and a preserved account.

Step 204: Determine whether a user corresponding to the preserved account complies with a predetermined principle. If the user corresponding to the preserved account does not comply with the predetermined principle, process step 206; otherwise, process step 208.

Step 206: Permit uploading or editing at least one individual information via the administer account for the cloud server system 12.

Step 208: Authorize the user corresponding to the preserved account to upload or edit the at least one individual information for the cloud server system 12.

In step 202, users are allowable to register to the cloud server system 12 with individually adaptive registering information, such as a user account, a password thereof, and/or some basic information to distinguish one from others. Specifically, the embodiment of the invention may provide two kinds of registering accounts, one is an administer account and the other is a preserved account. The administer account is utilized for an adult, such as parents or a person having an age to be responsible to others, and the preserved account is utilized for a child regulated under a children online privacy limitation, such as a child having an age younger than 13 years old regulated in the Children's Online Privacy Protection Act (COPPA) of the US Protection Law.

Before the child is capable of registering to the cloud server system 12, their parents, being the legal guardian and utilizing the administer account(s), are the right persons to assist the registration of the preserved account. In other words, the user(s) corresponding to the administer account, usually more than one but not limiting to, can register the administer account(s) as well as the preserved account in advance. Alternatively, if the child is capable of registering to the cloud server system 12, he/she can spontaneously register the preserved account, or his/her parents can assist the registration of the preserved account as well. Besides, the embodiment of the invention is not limiting the registration and the corresponding authorization of the cloud server system 12. For example, an electronic authorization as a password or a biological authorization as a facial/iris detection can be applied to satisfy the users' convenience, such that the user can easily utilize their digital devices (e.g. a mobile device or a tablet via a wireless connection) to access/communicate with the cloud server system 12, which is also within the scope of the invention.

Specifically, the embodiment of the invention provides the realization that the user utilizing the administer account should be a legal guardian of the user utilizing preserved account, and a number of the administer/preserved account being in a guardian/guarded relationship can be the case as one-to-one, one-to-multiple or multiple-to-multiple, e.g. one child corresponding to one parent, more than one child corresponding to one parent, one child corresponding to more than one parent and more than one child corresponding to more than one parent, which is not limiting the scope of the invention. Also, the cloud server system 12 may initially install a predetermined principle as the children online privacy limitation to adaptively control/confine children's behaviors through the Internet, and the cloud server system 12 can dynamically update the age of the user corresponding to the preserved account if the user corresponding to the preserved account has successfully registered. Accordingly, after the users corresponding to the administer/preserved accounts have registered to the cloud server system 12, different restrictions/authorities are applied to the users corresponding to the administer/preserved accounts, respectively. More details can be understood in the following paragraphs.

In step 204, the cloud server system 12 determines whether the user corresponding to the preserved account complies with the predetermined principle to further check whether the user corresponding to the preserved account is equal to or older than a default age being responsible for his/her behaviors through the Internet. For example, the default age of the embodiment of the invention is 13 years old regulated in the COPPA, and those skilled in the art can adaptively modify the default age according to different restrictions/protections regulated in different countries, which is not limiting the scope of the invention. Accordingly, if the user does not comply with the predetermined principle, i.e. the user corresponding to the preserved account is younger than the default age, the cloud server system 12 undergoes step 206. Otherwise, if the user corresponding to the preserved account is equal to or older than the default age, the cloud server system 12 undergoes step 208.

In step 206, the cloud server system 12 of the invention permits the user corresponding to the administer account for uploading or editing the at least one individual information in the cloud server system 12. Herein, the at least one individual information represents a personal identification for the user corresponding to the preserved account, i.e. the individual information represents a personal information for the user corresponding to the preserved account or a plurality of historical events of the user corresponding to the preserved account. For example, the individual information can be digitally realized as a text, a video, an audio or a recording file via any digital media recorder. The personal information can be a message transmitted from the parents to their children, a notice for a discussion hosted by the parents, or a message transmitted to a particular user corresponding to the preserved account. The plurality of historical events of the user corresponding to the preserved account can be a grown-up information indicating an educational record from school or cram-school, a health record, a memory record before the user corresponding to the preserved account turns into 13 years old, and/or an interactive record with surrounding people (e.g. classmates, teachers, friends, neighbors, and so on) , etc. In short, any information which can be digitalized and uploaded to the cloud server system 12 to be remembered for the user corresponding to the preserved account can be taken as the individual information of the invention.

Specifically, if the user corresponding to the preserved account fails to comply with the predetermined principle, the user corresponding to the administer account is given a authority to edit, read or upload the at least one individual information to the cloud server system 12. In comparison, the user corresponding to the preserved account is only allowable to read, rather than to edit nor to upload, the at least one individual information. In other words, the user corresponding to the preserved account only possess a limited authority (or right) of reading the uploaded individual information from the user(s) corresponding to the administer account(s), i.e. the parents/legal guardian, before complying with the predetermined principle. Contrarily, each user corresponding to the administer account has a broaden authority to edit/read/upload the at least one individual information in the cloud server system 12 before the user corresponding to the preserved account (i.e. his/her child) complies with the predetermined principle.

Although the user corresponding to the administer account is allowable to edit or upload the at least one individual information, few limitations may be still applied to the user corresponding to the administer account of the invention. In detail, the user corresponding to a first administer account is allowable to edit or read a first individual information uploaded by him-/herself, and the user corresponding to a second administer account is allowable to edit or read a second uploaded individual information uploaded by him-/herself. However, the user corresponding to the first administer account is only allowable to read, rather than to edit or delete, the second individual information, and the user corresponding to second administer account is only allowable to read, rather than to edit or delete, the first individual information. In short, in step 206, each user corresponding to the administer account has his/her own space to edit/manage/upload the corresponding individual information, and the user corresponding to the preserved account (i.e. the child to be guarded under the default age) is limited to read, rather than edit, the individual information.

Alternatively, if the user corresponding to the first administer account gives the permission to the user corresponding to the second administer account, the user corresponding to the second account may allow to edit and manage the first individual information uploaded by the user corresponding to the first administer account. In other words, the user corresponding to one administer account have the right to allow other users corresponding to different administer accounts to cooperate for accessing and editing his own space and the uploaded individual information therein, which is not limiting the scope of the invention.

Noticeably, if the guardian relationship between the user corresponding to the administer account and the user corresponding to the preserved account is changed before the user corresponding to the preserved account complies with the predetermined principle, the authority of the user corresponding to the administer account may adaptively adjust/change. For example, there are two users corresponding to the first administer account and the second administer account, respectively, (i.e. a father corresponding to the first administer account and a mother corresponding to the second administer account) and their legal guardian (i.e. their child) corresponding to the preserved account is younger than 13 years old. If the father and the mother get divorce, and the mother delegalizes to be the legal guardian of her child. Under such circumstances, the embodiment of the invention may update the latest guardian relationship to readjust the authority of the mother corresponding to the second administer account, such that, obeying a disagreement from the father or a declaration from the court, the second administer account utilized by the mother may be forbidden to edit the at least one individual information or to upload another individual information, i.e. the mother is only allowable to read, rather than to edit or manage, the at least one individual information, so as to protect the child under the legal declaration. Similarly, if the child is abused by his/her legal parents and the court has made the declaration to transfer his/her legal guardian to a third party, the cloud server system 12 may correspondingly adjust the authority of the administer accounts of his/her parents, which is also within the scope of the invention.

In step 208, the cloud server system 12 may authorize the user corresponding to the preserved account to upload or edit the at least one individual information for the cloud server system 12 if the user corresponding to the preserved account complies with the predetermined principle. Specifically, if the user corresponding to the preserved account is regarded as a responsible person through the Internet without the guardian from his/her parents, the authority of managing the at least one individual information, which is utilized to memory the childhood for the user corresponding to the preserved account, is reassigned to the user corresponding to the preserved account from the user corresponding to the administer account. Also, the user corresponding to the administer account is not necessary to guard/record/manage the at least one individual information for the user corresponding to the preserved account. Certainly, after the user corresponding to the preserved account complies with the predetermined principle, the user corresponding to the preserved account can further determine whether the user corresponding to the administer account continuously edits or manages the at least one individual information or uploads another individual information to the cloud server system 12. In short, the embodiment of the invention provides more flexibilities for the management of the at least one individual information after the child is older than the default age to be free from the guardian of his/her parents, which is not limiting the scope of the invention.

The embodiments of the invention focus on the at least one individual information uploaded by the user corresponding to the administer account, and the user corresponding to the administer account has the right/management to control the user corresponding to the preserved account for accessing the at least one individual information uploaded by the user corresponding to the administer account. Certainly, if the user corresponding to the preserved account is capable of uploading and recording his/her individual information of the invention, the cloud server system 12 of the invention also preserves an individual editing space for the user corresponding to the preserved account, such that the user corresponding to the preserved account may actively upload the at least one individual information or a personal information recorded/written/edited by himself/herself to be realized as a text, a picture, a voice or a audio, which is also within the scope of the invention.

Additionally, the embodiment of the invention is not limiting the interactive way between the user corresponding to the administer account and the user corresponding to the preserved account. For example, a message, an interactive move/hit/response for the at least one individual information or the individual editing space can be the communication, or a delivering message between the users of the administer/preserved accounts can also be the communication/interaction thereof, which is not limiting the scope of the invention.

Furthermore, the embodiments of the invention discuss the management of the at least one individual information to be transferred from the user corresponding to the administer account (or users corresponding to the administer accounts) to the user corresponding to the preserved account. In short, the predetermined principle of the invention is utilized as a transferring mechanism of the cloud server system 12 to determine whether or not to transfer/change/modify the authorization/right/management of the at least one individual information. Also, if the user corresponding to the administer account permits the user corresponding to the preserved account to manage/edit the at least one individual information before the predetermined principle is satisfied, the management of the at least one individual information may be transferred from the user corresponding to the administer account (or users corresponding to the administer accounts) to the user corresponding to the preserved account in advance, which is not limiting the scope of the invention.

Since the at least one individual information corresponding to the user utilizing the preserved account can represent the personal identification, each user corresponding to the preserved account may be organized and classified into different classification groups, which are administered by some administrative users. Specifically, the administrative users may occupy in a health, education, game or commercial application, or any related occupation to legally possess the individual information of the user corresponding to the preserved account. While the user corresponding to the preserved account does not comply with the predetermined principle and a permission of the user corresponding to the administer account is obtained, the cloud server system 12 can adaptively share or transmit the at least one individual information representing the personal identification of the user corresponding to the preserved account to the different classification groups of the administrative users.

Furthermore, the administrative users can dynamically manage/control members of the classification groups, e.g. adding or deleting the personal identification of the user corresponding to the preserved account for updating a corresponding membership list of the classification groups. Under such circumstances, the user corresponding to the preserved account can obtain related services from the classification groups. Also, the classification groups hosted by the administrative users may adopt different requirements or principles for the newly added members, such that it is convenient for the administrative users to organize operations of the classification groups via a pop-up notice or message, which is not limiting the scope of the invention.

In detail, the classification group can be a class or a school attended by the user corresponding to the preserved account, or a hospital or a shopping mall ever visited by the user corresponding to the preserved account. Accordingly, the related services can be a communication from a teacher to the parents, a notification from a hospital to a baby or patient for vaccine injection or medication, or a coupon containing items interested by the user of the preserved account, and so on. In other words, the embodiment of the invention renders the classification operation for the user corresponding to the preserved account (or the administer account), such that the corresponding individual information can be a classification mechanism for the administrative users of different classification groups to properly transmit/deliver the desired information/services to the user corresponding to the preserved account (or the administer account), which is not limiting the scope of the invention.

In the meanwhile, if the user corresponding to the first/second administer account finds that the information/services from the classification groups contain contents being harmful/illegal to the user corresponding to the preserved account, a prohibition form the user corresponding to the first/second administer account may be correspondingly generated/delivered to the cloud server system 12 to prevent the sharing of the at least one individual information to the other administrative users, or to removing the related services for the user corresponding to the preserved account . In other words, the user corresponding to the first/second administer account also provides a monitoring mechanism to adaptively protect the user corresponding to the preserved account from illegal or harmful contents and information, which is also in the scope of the invention.

Further, if the user corresponding to the preserved account request to purchase something or make a commercial contract with an on-line shop/website via the cloud server system 12, a corresponding request message for the purchase may be generated to be transmitted to the user corresponding to the first/second administer account, such that the user corresponding to the first/second administer account may directly approve the purchase by returning a acknowledge message to the user corresponding to the preserved account, so as to authorize the purchase or the commercial contract between the user corresponding to the preserved account and the on-line shop/website. In the embodiment, the acknowledge message may be realized as a text agreement from the user corresponding to the first/second administer account to the user corresponding to the preserved account. In another embodiment, the request message may contain a purchase list to be ordered/shopped by the user corresponding to the preserved account, and the acknowledge message may be a paid check or a purchased credit card action after the user corresponding to the first/second administer account properly overviews and picks some/all items in the purchase list, which is not limiting the scope of the invention. Alternatively, the cloud server system 12 of the invention may cooperate with an official bank for providing practically personal accounts associated with the user corresponding to the preserved account as well as the first/second administer account, such that after a permission from the user of the first/second administer account, the user corresponding to the preserved account may correspondingly pay the ordered item(s) via his/her own bank account in cash or via a credit card. Also, the user corresponding to the first/second administer account may pay the ordered item(s) for the user corresponding to the preserved account via his/her own bank account while receiving the request message; or an amount of tokens or credit points as a virtual payment, which may be issued by the bank or a responsible third party with limited/unlimited periods, may be transferred from the user corresponding to the first/second administer account to the user corresponding to the preserved account for paying the ordered item(s), which is also within the scope of the invention. In short, more transactions between the on-line shop/website and the user corresponding to the preserved account may be anticipated with payments, such as a practical bank account, a credit card or a virtual payment, for paying the ordered item(s) under adaptive monitoring from the user corresponding to the first/second administer account. Certainly, the payment in the embodiment can also be realized as other formats representing creditable transactions to finish the commercial actions/deals between the on-line shop/website and the user corresponding to the preserved/administer account, which is not limiting the scope of the invention.

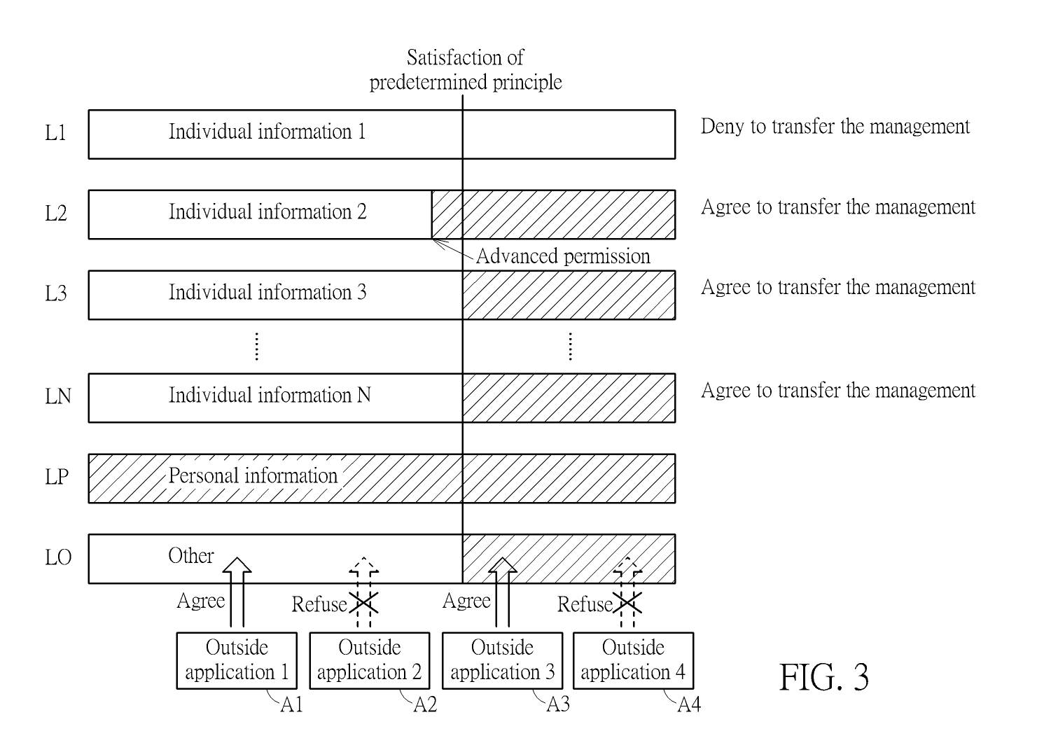

Please refer to FIG. 3, which illustrates a timing diagram with related information of the user corresponding to the preserved account in the cloud server system 12 according to an embodiment of the invention. As shown in FIG. 3, a plurality of information logs are depicted to represent different management of the related information to be transferred or not along with time passing through. For example, a first editing space comprises information logs Li-LN representing the individual information 1-N to be uploaded by the user corresponding to the first/second administer account. A second editing space comprises an information log LP representing the personal information to be edited or managed by the user corresponding to the preserved account. A third editing space comprises an information log LO representing other applications (or related services thereof) to be provided to the user corresponding to the preserved account from the other administrative users. Especially, the information log additionally depicting with an oblique line represents a successful transferring result of the management for the related information from the user corresponding to the first/second administer account to the user corresponding to the preserved account, such that the information log with the oblique line is totally managed or edited by the user corresponding to the preserved account, or the information log being not depicted the oblique line represents that the management of the related information is not transferred, i.e. the user corresponding to the first/second administer account still manages or edits the individual information.

Before the predetermined principle is satisfied or the default age is achieved, the information logs L1-LN are authorized to be edited or managed by the user corresponding to the first/second administer account. Once an advanced permission is given by the user corresponding to the first/second administer account, such as the information log L2, or the predetermined principle is satisfied (or the default age is achieved), such as the information logs L3-LN, the management of the information logs maybe adaptively transferred from the user corresponding to the first/second administer account to the user corresponding to the preserved account. An exception of the transferring of the management of the related information is the information log L1, i.e. the user corresponding to the first/second administer account may refuse to transfer the management of the individual information 1, such that the user corresponding to the preserved account may only allow to read rather to edit or manage the individual information 1 in the information log L1. Besides, the personal information is totally authorized or managed by the user corresponding to the preserved account. Similarly, the outside application 1 A1 and the outside application 2 A2 are authorized or managed by the user corresponding to the first/second administer account, and accordingly, a permission or a refusal may be given by the user corresponding to the first/second administer account to allow or prohibit the access of the outside applications for the user corresponding to the preserved account. Once the predetermined principle is satisfied or the default age is achieved, the user corresponding to the preserved account has the authorization/right to determine whether to process/access the outside applications, e.g. the outside application 3 A3 is allowed to be accessed and the outside application 4 A4 is prohibited to be accessed. All the mentioned number of the information log and outside application, the management to be transferred or the agreement/refusal of the outside application may be utilized only for clear demonstration, which is not limiting the scope of the invention.

In addition, the cloud server system 12 of the embodiment also comprises a historical recording module, and the user corresponding to the preserved account can be adaptively monitored, via the historical recording module, while being not complied with the predetermined principle, such that all surfing/accessing/editing histories of the user corresponding to the preserved account into/onto the cloud server system 12 can be correspondingly recorded with a permission of the user of the first/second administer account. Accordingly, the user of the first/second administer account may correspondingly receive a recording report from the cloud server system 12 to understand all surfing/accessing/editing histories of the user corresponding to the preserved account into/onto the cloud server system 12. Further, the user corresponding to the first/second administer account may try to implement some restrictions onto some surfing/editing/accessing authorities of the user corresponding to the preserved account if he/she finds it necessary. Besides, the recording report of the embodiment can be realized as a list/table briefly containing titles of different types/dates of surfing/accessing/editing histories of the user corresponding to the preserved account, and the titles may also respectively attach with detailed information to clearly demonstrate or describe the surfing/accessing/editing histories. Also, the user corresponding to the first/second administer account can determine when or how to receive the recording report with his/her preference, e.g. periodically receiving via a notice message from the cloud server system 12 or latest showing the reporting report via a pop-up message, which is not limiting the scope of the invention.

Noticeably, the embodiment of the invention provides the fundamental principles for different registering users of the cloud server system 12, such that the authority of editing or reading of the at least one individual information for different registering users can be adaptively modified. Certainly, those skilled in the art can modify/adjust/change the predetermined principle of the invention to be cooperated with different limitations/regulations for the administer/preserved account. For example, an additional principle can be that any registered user being contained in the individual information is capable of editing or requesting to edit the individual information, which is also in the scope of the invention. Besides, the user corresponding to the administer account can upload other personal information not related to the user corresponding to the preserved account to be shared/stored via the cloud server system 12, which is also within the scope of the invention.

In summary, the embodiments of the invention provide two registering account corresponding to different users with different authority to edit/read/upload the individual information in a cloud server system. While the user corresponding to the preserved account is younger than the default age, the user corresponding to the administer account is capable to edit or upload the individual information to be remembered for the user corresponding to the preserved account. While the user corresponding to the preserved account is equal to or older than the default age, the user corresponding to the preserved account (or both the users corresponding to the administer/preserved account) is capable to edit or upload the individual information. Accordingly, the cloud server system of the embodiment can be utilized to store the childhood memories for the immature people (i.e. the people being younger than the default age), and other registered administrative users can utilized the classified personal information to properly select the potential customer with adaptive related services, so as to broaden the application of the cloud server system of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A management method for a cloud server system, the management method comprising:
accepting registering of a first administer account and a preserved account; and
permitting uploading or editing at least one individual information via the first administer account for the cloud server system while a user corresponding to the preserved account does not comply with a predetermined principle, or authorizing the user corresponding to the preserved account to upload or edit the at least one individual information for the cloud server system while the user corresponding to the preserved account complies with the predetermined principle;
wherein the predetermined principle is a children online privacy limitation, a user corresponding to the first administer account is a legal guardian for the user corresponding to the preserved account, and the at least one individual information represents a personal identification for the user corresponding to the preserved account.

2. The management method of claim 1, wherein the predetermined principle is an age of the user corresponding to the preserved account being equal to or older than 13 years old regulated in the Children's Online Privacy Protection Act (COPPA).

3. The management method of claim 1, wherein the user corresponding to the preserved account is allowable to read, rather than to edit or upload, the at least one individual information, and the user corresponding to the first administer account is allowable to edit, upload and read the at least one individual information.

4. The management method of claim 1, wherein the individual information represents a personal information for the user corresponding to the preserved account or a plurality of historical events of the user corresponding to the preserved account.

5. The management method of claim 1, further comprising utilizing an electronic authorization or a biological authorization to receive registering information of the first administer account and the preserved account.

6. The management method of claim 1, further comprising permitting uploading or editing the individual information via a user corresponding to a second administer account, who is also the legal guardian for the user corresponding to the preserved account, but is not authorized to edit the uploaded individual information by the first administer account.

7. The management method of claim 6, further comprising while the user corresponding to the preserved account does not comply with the predetermined principle, forbidding the user corresponding to the second administer account to edit the at least one individual information or upload another individual information if the user corresponding to the second administer account delegalizes to be the legal guardian of the user corresponding to the preserved account.

8. The management method of claim 1, further comprising while the user corresponding to the preserved account does not comply with the predetermined principle and a permission of the user corresponding to the first administer account is obtained, sharing the at least one individual information to other administrative users, who occupy in a health, education, game or commercial application, or any related occupation to legally possess the individual information of the user corresponding to the preserved account.

9. The management method of claim 8, further comprising permitting adding or deleting the personal identification from a classification group via one of the other administrative users, such that the user corresponding to the preserved account obtains related services from the classification group.

10. The management method of claim 9, further comprising prohibiting the sharing of the at least one individual information to the other administrative users, or removing, via the user corresponding to the first administer account, the related services for the user corresponding to the preserved account.

11. The management method of claim 1, further comprising while the user corresponding to the preserved account complies with the predetermined principle, determining whether the user corresponding to the first administer account continuously edits the at least one individual information or uploads another individual information.

12. The management method of claim 1, further comprising waiting the predetermined principle being satisfied or receiving a permission from the user corresponding to the first administer account, transferring a management of the at least one individual information from the user corresponding to the first administer account to the user corresponding to the preserved account.

13. The management method of claim 1, wherein the cloud server system comprises a first editing space for storing the at least one individual information, a second editing space for storing a personal information and a third editing space for storing at least one outside application, wherein the personal information is only edited or managed by the user corresponding to the preserved account rather than the user corresponding to the first administer account, and the at least one outside application is provided from other administrative users.

14. The management method of claim 1, further comprising recording a surfing/accessing/editing history of the user corresponding to the preserved account to be a recording report transmitted to the user corresponding to the first administer account, and allowing a restriction from the user corresponding to the first administer account to be implemented onto a surfing/accessing/editing authority of the user corresponding to the preserved account.

15. The management method of claim 1, further comprising accepting a purchase from the user of the preserved account after receiving a permission from the user of the first administer account, and paying the purchase via a personal bank account, a credit card or a virtual payment.

16. A computer system, coupled to a cloud server system, the computer system comprising:
a central processing unit; and
a storage device, coupled to the central processing unit and storing a programming code, the programming code is utilized to process a management method for the cloud server system, the management method comprising:
accepting registering of a first administer account and a preserved account; and
permitting uploading or editing at least one individual information via the first administer account for the cloud server system while a user corresponding to the preserved account does not comply with a predetermined principle, or authorizing the user corresponding to the preserved account to upload or edit the at least one individual information for the cloud server system while the user corresponding to the preserved account complies with the predetermined principle;
wherein the predetermined principle is a children online privacy limitation, a user corresponding to the first administer account is a legal guardian for the user corresponding to the preserved account, and the at least one individual information represents a personal identification for the user corresponding to the preserved account.

17. The computer system of claim 16, wherein the predetermined principle is an age of the user corresponding to the preserved account being equal to or older than 13 years old regulated in the Children's Online Privacy Protection Act (COPPA).

18. The computer system of claim 16, wherein the user corresponding to the preserved account is allowable to read, rather than to edit, the at least one individual information, and the user corresponding to the first administer account is allowable to edit, upload and read the at least one individual information.

19. The computer system of claim 16, wherein the individual information represents a personal information for the user corresponding to the preserved account or a plurality of historical events of the user corresponding to the preserved account.

20. The computer system of claim 16, wherein the management method further comprises utilizing an electronic authorization or a biological authorization to receive registering information of the first administer account and the preserved account.

21. The computer system of claim 16, wherein the management method further comprises permitting uploading or editing the individual information via a user corresponding to a second administer account, who is also the legal guardian for the user corresponding to the preserved account, but is not authorized to edit the uploaded individual information by the first administer account.

22. The computer system of claim 21, wherein the management method further comprises while the user corresponding to the preserved account does not comply with the predetermined principle, forbidding the user corresponding to the second administer account to edit the at least one individual information or upload another individual information if the user corresponding to the second administer account delegalizes to be the legal guardian of the user corresponding to the preserved account.

23. The computer system of claim 16, wherein the management method further comprises while the user corresponding to the preserved account does not comply with the predetermined principle and a permission of the user corresponding to the first administer account is obtained, sharing the at least one individual information to other administrative users, who occupy in a health, education, game or commercial application, or any related occupation to legally possess the individual information of the user corresponding to the preserved account.

24. The computer system of claim 23, wherein the management method further comprises permitting adding or deleting the personal identification from a classification group via one of the other administrative users, such that the user corresponding to the preserved account obtains related services from the classification group.

25. The computer system of claim 24, wherein the management method further comprises prohibiting the sharing of the at least one individual information to the other administrative users, or removing, via the user corresponding to the first administer account, the related services for the user corresponding to the preserved account.

26. The computer system of claim 16, wherein the management method further comprises while the user corresponding to the preserved account complies with the predetermined principle, determining whether the user corresponding to the first administer account continuously edits the at least one individual information or uploads another individual information.

27. The computer system of claim 16, wherein the management method further comprises waiting the predetermined principle being satisfied or receiving a permission from the user corresponding to the first administer account, transferring a management of the at least one individual information from the user corresponding to the first administer account to the user corresponding to the preserved account.

28. The computer system of claim 16, wherein the cloud server system comprises a first editing space for storing the at least one individual information, a second editing space for storing a personal information and a third editing space for storing at least one outside application, wherein the personal information is only edited or managed by the user corresponding to the preserved account rather than the user corresponding to the first administer account, and the at least one outside application is provided from other administrative users.

29. The computer system of claim 16, wherein the cloud server system further comprises a historical recording module for recording a surfing/accessing/editing history of the user corresponding to the preserved account to be a recording report transmitted to the user corresponding to the first administer account, and the cloud server system receives a restriction from the user corresponding to the first administer account to be implemented onto a surfing/accessing/editing authority of the user corresponding to the preserved account.

30. The computer system of claim 16, wherein the management method further comprises accepting a purchase from the user of the preserved account after receiving a permission from the user of the first administer account, and paying the purchase via a personal bank account, a credit card or a virtual payment.
